(19) United States
(12) Patent Application Publication
(10) Pub. No.: US 2024/0282504 A1
(43) Pub. Date: Aug. 22, 2024

(54) Inertially-Damped Segmented Coils for Generating High Magnetic Fields

(71) Applicant: Helion Energy, Inc., Everett, WA (US)

(72) Inventors: Brian Campbell, Shoreline, WA (US); David Kirtley, Seattle, WA (US); Christopher James Pihl, Woodinville, WA (US); Akihisa Shimazu, Seattle, WA (US)

(73) Assignee: Helion Energy, Inc., Everett, WA (US)

(21) Appl. No.: 18/570,399

(22) PCT Filed: Jun. 14, 2022
(86) PCT No.: PCT/US2022/033424

§ 371 Date: Dec. 14, 2023

Related U.S. Application Data
(60) Provisional application No. 63/210,416, filed on Jun. 14, 2021.

(51) Int. Cl. H01F 27/26; H01F 27/34

(52) U.S. Cl. CPC H01F 27/26; H01F 27/34

(57) ABSTRACT

A multi-fed, multi-segmented magnetic coil assembly includes inertial dampers that can avoid excessive strain on core portions and fasteners that hold core portions of the magnetic coil together. Energy-absorbing elements are used to absorb and dissipate kinetic energy of oscillating components of the magnetic coil that result from high magnetic pressure acting on core segments. The inertial dampers and energy-absorbing elements can be selected to critically damp or overdamp mechanical oscillation in the magnetic coil assembly, allowing continuous repeated production of intense magnetic fields.

### CROSS-REFERENCE TO RELATED APPLICATIONS

The present application claims a priority benefit, under 35 U.S.C. § 119(e), to U.S. provisional application Ser. No. 63/210,416 filed on Jun. 14, 2021, titled “Inertially-Damped Segmented Coils for Generating High Magnetic Fields,” which application is incorporated herein by reference in its entirety.

### BACKGROUND

Intense magnetic fields may be generated with a plurality of current-carrying coils that are driven with large electrical currents and high voltages. Such magnetic fields may be used to confine high-energy particles and/or to accelerate particles or objects to high velocities. In some cases, the magnetic fields may be used to confine a plasma. In some cases, the magnetic pressure on the coils may reach levels that approach the yield strength of coil components. If the yield strength is exceeded, damage to the coils can occur.

### SUMMARY

The described implementations relate to inertial damping in segmented magnetic coils that may be used to produce intense electromagnetic fields. For example, one or more magnetic coils may be used to create a pulse of electromagnetic field in a spatial volume where the peak magnetic field strength can exceed 0.01 Tesla (T) and in some cases may be as high as 50 T. In such applications, large electromagnetic forces can be exerted back on components of the coil(s). The forces may act to drive the components of the coil(s) apart, such that they must be held in place with strong structural elements that can resist the induced motion of the components. Inertial damping elements can be included in these structural elements to resist oscillatory motion of the components and prolong the working lifetime of the coil(s).

Some implementations relate to a magnetic coil assembly comprising a first core portion partially surrounding a cavity of the magnetic coil assembly to carry a first electrical current to contribute to creating a magnetic field in the cavity and a second core portion partially surrounding the cavity to carry a second electrical current to contribute to creating the magnetic field. The second core portion and the first core portion are configured to be electrically insulated from each other when the first core portion and the second core portion are not connected to one or more supply circuits. The assembly can further include a first element mechanically coupled to the first core portion and having a first mass, a second element mechanically coupled to the second core portion and having a second mass, and a first energy-absorbing element coupled to at least the first element to absorb first kinetic energy from motion of at least the first element in response to magnetic pressure on the first core portion and on the second core portion resulting from the creation of the magnetic field and to dissipate at least a portion of the absorbed first kinetic energy. The magnetic coil assembly can also include at least one fastener that mechanically couples the first element to the second element to restrain movement of the first core portion away from the second core portion in response to the magnetic pressure.

Some implementations relate to methods of operating a magnetic coil assembly. Such methods can include acts of: flowing a first electrical current in a first core portion that carries the first electrical current partially around a cavity, wherein the first core portion partially surrounds the cavity; flowing a second electrical current in a second core portion that carries the second electrical current partially around the cavity, wherein the second core portion partially surrounds the cavity; creating a magnetic field in the cavity in response to flowing the first electrical current and the second electrical current; restraining, with a first element that is mechanically coupled to the first core portion, outward motion of the first core portion from the cavity in response to first magnetic pressure on the first core portion resulting from creation of the magnetic field, wherein the first element has a first mass; and restraining, with a second element that is mechanically coupled to the second core portion and to the first element with at least one fastener, outward motion of the second core portion from the cavity in response to second magnetic pressure on the second core portion resulting from the creation of the magnetic field, wherein the second element has a second mass; absorbing, with a first energy-absorbing element coupled to at least the first element, first kinetic energy from motion of at least the first element in response to at least the first magnetic pressure on the first core portion; and dissipating at least a portion of the absorbed first kinetic energy.

Some implementations relate to a magnetic coil assembly comprising a first core portion partially surrounding a cavity of the magnetic coil assembly to carry a first electrical current to contribute to creating a magnetic field in the cavity and a second core portion partially surrounding the cavity to carry a second electrical current to contribute to creating the magnetic field. The second core portion and the first core portion are electrically insulated from each other when the first core portion and the second core portion are not connected to one or more supply circuits. The magnetic coil assembly can further include a first element mechanically coupled to the first core portion and having a mass at least 0.5 times a mass of the first core portion, a second element mechanically coupled to the second core portion and having a mass at least 0.5 times a mass of the second core portion, and at least one fastener that mechanically couples the first element to the second element to restrain movement of the first core portion away from the second core portion in response to magnetic pressure on the first core portion and on the second core portion resulting from the creation of the magnetic field.

All combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein. The terminology explicitly employed herein that also may appear in any disclosure incorporated by reference should be accorded a meaning most consistent with the particular concepts disclosed herein.

### BRIEF DESCRIPTIONS OF THE DRAWINGS

The skilled artisan will understand that the drawings primarily are for illustrative purposes and are not intended to limit the scope of the inventive subject matter described herein. The drawings are not necessarily to scale; in some instances, various aspects of the inventive subject matter disclosed herein may be shown exaggerated or enlarged in the drawings to facilitate an understanding of different features. In the drawings, like reference characters generally refer to like features (e.g., functionally similar and/or structurally similar components).

FIG. 1 depicts an elevation view of a magnetic coil of the related art.

FIG. 2 depicts, in elevation view, an example of a multi-fed, multi-segmented magnetic coil assembly with inertial damping.

FIG. 3A depicts an example of an insulator that may be used to electrically insulate a bolt from a magnetic coil component.

FIG. 3B depicts another example of an insulator that may be used to electrically insulate a bolt from a magnetic coil component.

FIG. 4A depicts a quarter-turn magnetic coil.

FIG. 4B depicts support structure for a quarter-turn magnetic coil.

FIG. 4C depicts alternative support structure for a quarter-turn magnetic coil.

FIG. 4D depicts another implementation of support structure for a quarter-turn magnetic coil.

FIG. 5A depicts axial support elements for a magnetic coil assembly having multiple fractional-turn cores.

FIG. 5B depicts axial support elements for another magnetic coil assembly design.

FIG. 6A depicts an arrangement of support structure for a magnetic coil assembly.

FIG. 6B depicts another view of the support structure for the magnetic coil assembly of FIG. 6A.

FIG. 7A illustrates a simplified circuit schematic of a supply circuit that can be used to deliver current to one or more core portions of a multi-fed, multi-segmented magnetic coil assembly, such as the assembly of FIG. 2.

FIG. 7B illustrates another simplified circuit schematic of a supply circuit that can be used to deliver current to one or more core portions of a multi-fed, multi-segmented magnetic coil assembly, such as the assembly of FIG. 2, and can recover some of the energy that passes through the core portions.

### DETAILED DESCRIPTION

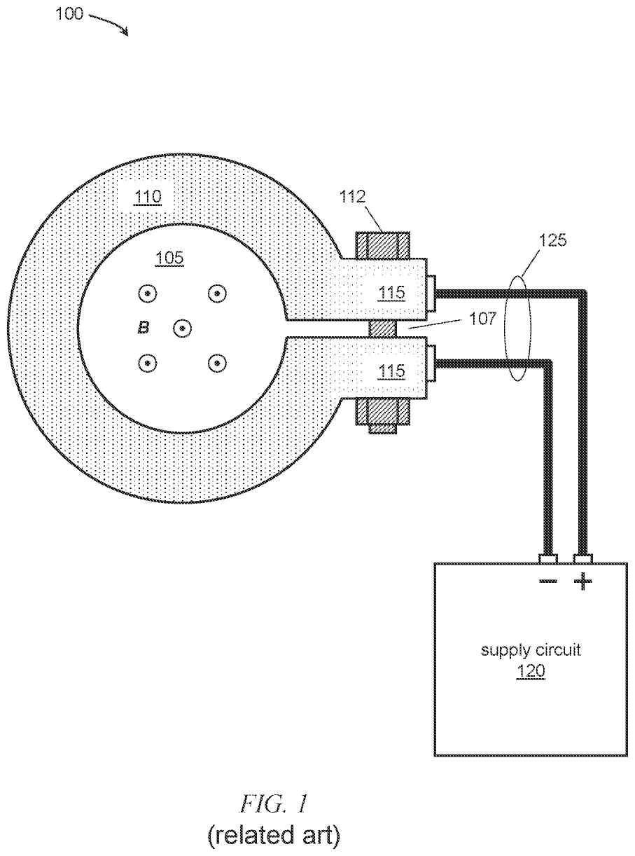

FIG. 1 depicts a magnetic coil 100 of the related art that may be used to produce intense magnetic fields. The magnetic coil 100 is driven by a supply circuit 120 that connects to the coil with coil supply lines 125. The supply circuit may supply enough current to the coil 100 via feed structures 115 to generate a peak magnetic field B of 0.5 Tesla, for example, in an enclosed cavity or space 105 that is surrounded by a core 110 of the magnetic coil 100. The coil's core 110 and feed structures 115 include an insulating gap 107 so that current delivered to the core 110 circulates around the enclosed space 105 to produce the magnetic field B. Because large currents and intense magnetic fields are involved, a gap bolt 112, which is insulated from the core 110 by insulating material (not shown), is used to prevent the core 110 from being irreversibly forced apart and damaged. The coil assembly of FIG. 1 may be referred to as a single-turn coil or single-segment coil.

The inventors have recognized and appreciated that in coil assemblies with magnetic fields of 0.5 Tesla and higher, which may be required for some applications, the gap bolt 112 may fatigue and crack during extended use. In some high-current, high-field applications, the yield strength of the gap bolt 112 may be exceeded when a current pulse of a useful magnitude is applied to the core 110. Additionally, there can be challenges when using high voltages to drive a sufficient amount of current through the core 110 to perform an operational function with the coil 100. For example, repeated motion of the core 110 and feed structures 115 with respect to the gap bolt 112 can lead to wear and/or cracking of an insulator between the gap bolt 112 and core and/or between the feed structures 115. Such wearing and cracking can eventually result in high-voltage arcing across the gap 107 or between the gap bolt and the core 110. Additionally, motion of the core 110 resulting from the application of large current pulses can fatigue and/or crack the core itself, requiring replacement of the core after a few pulses.

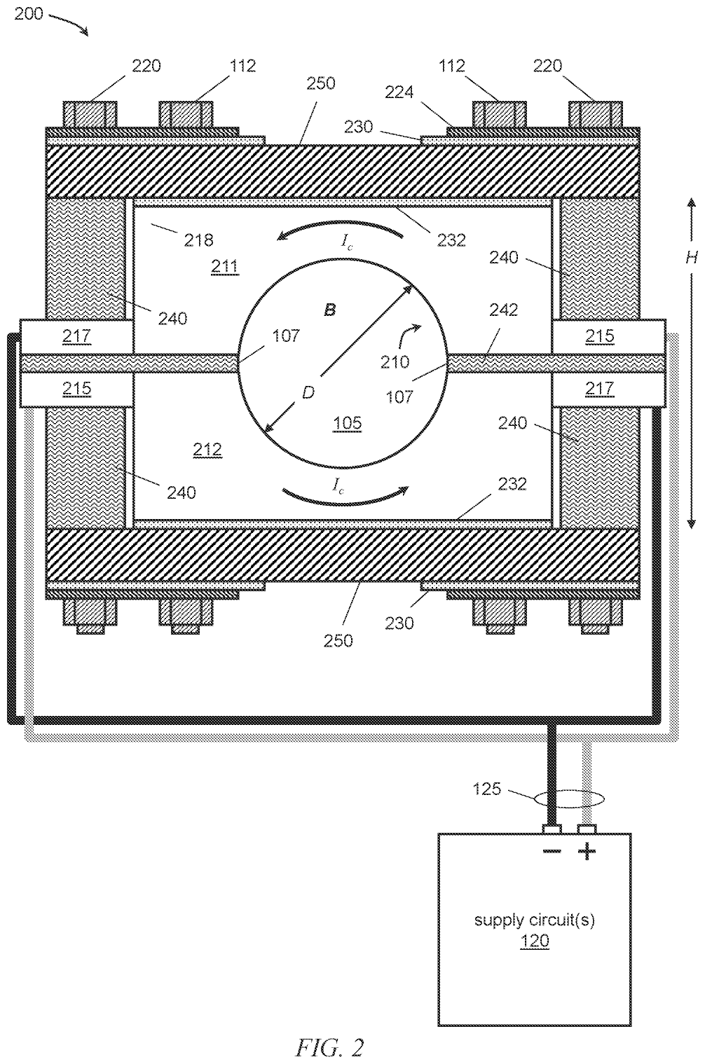

FIG. 2 depicts an elevation view of a multi-fed, multi-segmented magnetic coil assembly 200 and a supply circuit 120. The coil assembly 200 includes components for inertial damping to overcome some of the challenges presented for the magnetic coil 100 of FIG. 1. The multi-fed magnetic coil assembly 200 comprises a multi-segmented electromagnetic coil 210 that can include multiple core portions 211, 212. The core portions can be separately fed with current over coil supply lines 125 by one or more supply circuits 120. In some embodiments, voltage is applied to each core portion and current flows in each core portion at a same time (i.e., simultaneously). In other cases, voltage is applied at nearly the same time (e.g., in a rapid sequence) to each core portion in a specific pattern. The illustration shows two core portions 211, 212, though there can be more core portions (e.g., three, four, five, six, or more) that form a multi-segmented magnetic coil 210. The core portions can be separated by core gaps 107, such that the core portions are electrically insulated from each other when the core portions are not connected to one or more supply circuits. Although the magnetic coil 210 is depicted as having an outer rectangular shape in the drawing, the outer shape may be different than depicted (e.g., circular, oval, triangular, hexagonal, or some other polygonal shape). The multiple core portions can be mechanically coupled together (e.g., bolted and/or clamped together) to form the multi-fed, multi-segmented magnetic coil assembly 200 having an enclosed cavity or space 105 in which a magnetic field B is produced by a circulating current I_{c}. The enclosed space 105 may have a shape other than circular or spherical. In operation, the peak strength of the magnetic field B produced by one or more of the multi-segmented magnetic coils 210, when supplied with a pulse of current, may be from 0.01 Tesla (T) to 50 T, for example, or any sub-range between 0.01 T and 50 T. In some implementations, the peak magnetic field may have a value between 10 T and 40 T. In some cases, the peak magnetic field B may be more than 50 T.

An electrical advantage of the multi-segmented coil 210 is that the voltage drop around the multi-segmented coil is N×V where N is the number of core portions and V is the voltage of the supply circuit(s) applied to each core portion. A supply circuit can apply a same voltage V to each core portion of the magnetic coil assembly. Accordingly, the same supply circuit can provide N times as much voltage drop around the coil for the multi-segmented coil 210 compared to the magnetic coil 100 of FIG. 1. Alternatively, a same amount of voltage drop around the entire multi-segmented coil can be achieved with a reduction of applied voltage by a factor of N compared to the single-turn magnetic coil 100 of FIG. 1. The latter case may reduce or eliminate the risk of high-voltage arcing in some applications. Alternatively, a same voltage of the supply circuit provides an effectively higher driving voltage for a multi-segmented coil than for a single-turn coil.

Another electrical advantage of the multi-segmented coil 210 is that dividing the core into N portions can allow some flexibility in impedance matching the core portions to the supply circuit(s) 120. This may allow, for example, shorter current pulses to be applied to the multi-segmented coil 210 with better power transfer than is possible with the magnetic coil 100 of FIG. 1.

In some cases, the core portions 211, 212 may be formed from a ferromagnetic material. In other cases, a non-magnetic material may be used to form the core portions 211 such as, but not limited to, alloys of aluminum, copper, stainless steel or other metals. For example, the core portions 211 may be machined from a high-strength aluminum alloy 7075-T6. In some implementations, the core portions can be formed from superconducting material. Each core portion may be formed (e.g., cast or machined) from a single piece of material.

A feed plate 215 or feed structure and a return plate 217 or return structure may connect to each core portion 211, 212 through which current flows to and from the core portion. A feed plate 215 of one core portion 211 may be adjacent to and separated by a distance (e.g., a gap) from a return plate 217 of an adjacent core portion 212. The feed plate and return plate can be structural features extending a distance from the associated core portion. The feed plate 215 and return plate 217 may include one or more clear holes and/or threaded holes for bolting to an adjacent return plate or feed plate. The feed plate 215 and return plate 217 may include one or more connectors to connect with one or more supply lines 125. In some cases, the feed plate 215 and/or return plate 217 may be integrally formed, at least in part, with its associated core portion. A width of the feed plate 215 and/or return plate 217 (in a direction into the page of the drawing) may be the same as, greater than, or less than a width of the core portion to which the plates are attached. In some cases, the width of the feed plate 215 may be different than the width of the return plate 217. An example diameter D of the enclosed space 105 within the multi-segmented magnetic coil 210 can have a value in a range from 1 centimeter (cm) to 300 cm, though in some cases the diameter may be larger. For coils where the enclosed space 105 does not have a circular cross section, the inner diameter D can be the smallest distance between opposing sides of the space. For a rectangular shape, the inner diameter would be equivalent to the short side of the rectangle, for example.

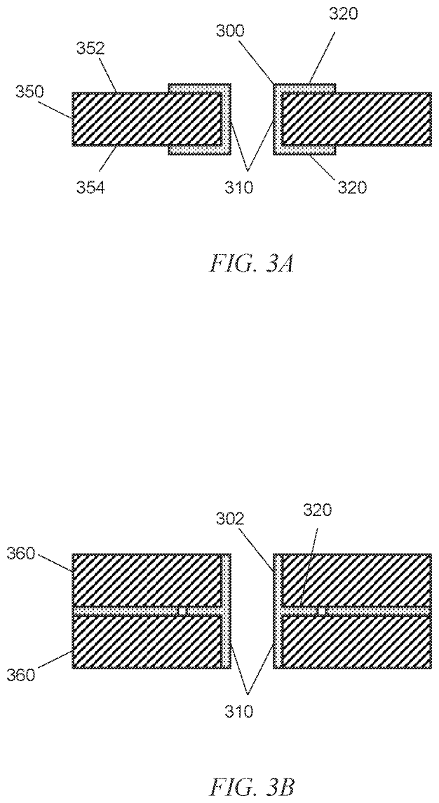

The multi-fed magnetic coil assembly 200 can further include inertial dampers 250 (which may also be referred to as “inertial-mass elements”) and fasteners (such as gap bolts 112 and damper bolts 220) that are arranged to hold the core portions 211, 212 together, as depicted in the example of FIG. 2. The gap bolts 112 and damper bolts 220 can be formed from high- strength steel or other alloy and may be grade 8 or metric class 12.9 strength bolts. There can be one or more gap bolts 112 and one or more damper bolts 220 located where each gap bolt and damper bolt is shown in FIG. 2 (e.g., a cluster of gap bolts instead of a single bolt). To maintain electrical isolation of the core portions from one another, the gap bolts 112 and damper bolts can be electrically insulated from the core portions. For example, the bolts may be sheathed with an insulator and/or holes in the core portions 211, 212 and/or inertial dampers 250 through which the bolts pass may be lined with an insulating layer, as described further below in connection with FIG. 3A and FIG. 3B.

The gap bolts 112 and damper bolts 220 can be located on opposing sides of the enclosed space 105. In some implementations, the feed plate 215 and/or return plate 217 may extend between damper bolts 220 (as illustrated) or may not extend to the damper bolts 220. When the feed plate 215 and/or return plate 217 extends between the damper bolts, there may be holes or slots in the feed plate 215 and/or return plate 217 to allow the damper bolts 220 to pass through the plate(s). When the feed plate 215 and/or return plate 217 does not extend to the damper bolt 220, electrical connections to the plate(s) may pass between two or more damper bolts 220. In some cases, the gap bolts 112 may not extend through the inertial dampers 250. Instead, heads and nuts of the gap bolts 112 may be located inside openings or blind holes of the inertial dampers 250.

The inventors have recognized and appreciated that for some high-field applications, the mass of the magnetic coil can be too light and the magnetic forces so high that halves of the magnetic coil can exert enough force on the gap bolt 112 and move enough to strain the gap bolt 112 beyond its elastic limit, exceeding its yield strength. Such a result can irreparably damage a magnetic coil, such as the coil depicted in FIG. 1. To avoid this outcome, inertial dampers 250 can be used to back the core portions 211, 212 as depicted in the example of FIG. 2. An inertial damper 250 can be formed from a heavy, non-magnetic material such as stainless steel or other alloy and may have a mass in a range from 0.5 to 50 times the mass of the core portion(s) which the inertial damper backs, or in any subrange between 0.5 and 50 times the mass of the core portion(s). For example, the mass of the inertial damper can have a value in a range from 0.25 to 2 times, from 0.5 to 4 times, or from 1 to 5 times the mass of the core portion(s) which the inertial damper backs. In some cases, the inertial damper 250 can have a mass of at least 0.5 times the mass of the core portion(s). Other metals and alloys may be used for the inertial dampers 250. For some implementations, the inertial damper 250 can be formed as a stack of metals (e.g., one or more stainless steel bars or plates interleaved or stacked with one or more lead bars or plates to increase mass). In some cases, an inertial damper 250 may be part of a plate that extends over one or more adjacent core portions for adjacent magnetic coils (arranged along a direction into and out of the page of the drawing).

In operation, a core portion 211 can exert an outward force against the damper 250 and heads (or nuts) of the gap bolts 112 and damper bolts 120 when a pulse of current I_{c} passes through the core portion. The pulse of current may have a full-width-half maximum (FWHM) duration of Δt. The value of Δt may be from 1 nanosecond to 1 second for example, though shorter or longer durations may be used in some applications. For some implementations, the FWHM duration of the pulse is less than 100 milliseconds. The amount of outward pressure that can be applied by the core portion can be up to or exceed 5000 atmospheres in some cases. This force can cause deformation, acceleration, and movement of the core portion 211, which causes stretching of the bolts. The total amount of movement of the core portion will be determined, in part, by the mass that must be moved and the duration and magnitude of the current pulse At. By adding more mass with the inertial damper 250, the total amount of movement of the core portion (and strain on the bolts) can be reduced.

Because there is movement of the core portions and elastic stretching of the gap bolts 112 and damper bolts 220, the inventors have recognized and appreciated that the core portions may rebound after the current pulse passes, head toward each other, collide with each other or intervening material, and then oscillate. Such mechanical oscillation may significantly reduce the working lifetime of the coil assembly 200. To mitigate this unwanted motion, energy-absorbing elements 240, 242 are added to damp the otherwise oscillatory motion of the core portions. The energy-absorbing elements 240, 242 can be formed from a polymer, fiber-reinforced polymer, fiberglass, ceramic, polymer-metal composite, or some combination thereof. In some cases, the energy-absorbing elements 240, 242 may comprise a laminate of different materials (e.g., layers of a hard material such as a fiber-reinforced polymer, phenolic plastic, high-strength polycarbonate, fiberglass, or metal that are interleaved with layers of a soft polymer such as silicone, polyethylene, or rubber). In some implementations, the energy-absorbing elements are selected and sized to overdamp or critically damp the otherwise oscillatory motion of the core portions. In some cases, the energy absorbing elements contribute to damping mechanical oscillation in the core such that the core oscillates for no more than a number of cycles in a range between 2 cycles and 20 cycles. There can be first absorbers 240 that extend in a direction between the inertial dampers 250. These absorbers can absorb and dissipate kinetic energy from at least the rebounding inertial dampers 250. There can be second absorbers 242 that extend at least between the core gaps 107. These absorbers can absorb and dissipate kinetic energy from at least the rebounding core portions 211, 212.

In some implementations, the first absorber 240 may be continuous and extend from one inertial damper 250 to another 250. For example, a first absorber 240 may pass through an opening in the feed plate 215, second absorber 242, and return plate 217 so that opposing ends of the first absorber 240 contacts each inertial damper 250. In other cases, a first absorber may terminate on a feed plate 215 or return plate 217 or may pass through a feed plate or return plate and terminate on the second absorber 242.

During operation, the inertial dampers 250 can flex as the core portions 211, 212 push into the inertial dampers. Such flexing can result in excessively high stress on certain regions of the core portions (e.g., at corners 218). One way to mitigate the high stress is to preload the inertial dampers 250 such that they initially exert more force on a center of the core portions 211, 212 than on the ends of the core portions. This can be done by forming the inertial damper as a curved bar or plate which contacts the center of the core portions first when the multi-fed magnetic coil assembly 200 is assembled. Additionally or alternatively, the first absorbers 240 can be made longer than the distance H between outer surfaces of the inertial-damper insulators 232 when the core portions 211, 212, second absorber 242, and inertial-damper insulators 232 are stacked together for assembly. This can preload the first absorbers 240 which push on the ends of the inertial dampers 250 and thereby reduce the stress that the ends of the inertial dampers 250 apply to the corners 218 of the core portions 211, 212 during a pulse of current through the core portions. Additionally or alternatively, the gap bolts 112 (when arranged such that their heads and nut contact the outer surfaces of the inertial dampers 250) may be tightened to a greater torque value than the damper bolts 220 to preload the inertial dampers 250 such that their centers exert more force on the centers of the core portions 211, 212 than the ends of the inertial dampers. However implemented, the preloading of the inertial damper 250 can apply more force to a central region 214 of the core portion 211 that is closer to the cavity 105 than to ends and/or corners 218 of the core portion that are farther from the cavity. Such preloading can be implemented for other fractional-turn coils described herein.

Multi-segmented magnetic coils 210 operating at high voltage may undesirably conduct to the exterior surroundings and/or may form closed loops with reference to a ground potential. When forming a closed loop, a coil can intercept significant magnetic flux and generated a voltage. To mitigate these effects, interstitial dielectric elements can be used between magnetic field coils or to fill voids within each coil assembly 200 (e.g., fill the coil gap 107). In addition to providing electrical isolation, these dielectric elements may provide structural support and/or damping of mechanical stress for the coil, as described above for the first absorber 240 and second absorber 242. Example materials that may be used for such purposes are fiberglass and/or advanced plastics such as G-10 and HDPE.

There can be additional insulating elements in a magnetic coil assembly 200, which elements are described further below. These elements include, but are not limited to, fastener insulators 230, 300, 302 and inertial-damper insulators 232. FIG. 3A and FIG. 3B depict examples of fastener insulators 300, 302 that may be used for electrical isolation. These additional insulating elements may also provide structural support and/or damping of mechanical stress. In some cases, the additional insulating elements absorb and dissipate kinetic energy from core portions as the core portions are driven apart by an applied current pulse. Some example materials for these insulating elements include, but are not limited to polymers, fiber-reinforced polymers, polymers with particulate material(s) dispersed within the polymer, and laminates. Example polymers include polyethylene (PE), high density polyethylene (HDPE), polyether ether ketone (PEEK), polyester, polyoxymethylene (POM), acrylonitrile butadiene styrene. An example laminate is G10 fiberglass laminate. In some cases, the insulating elements 230, 300, 302 may comprise a laminate of different materials (e.g., layers of a hard material such as a fiber-reinforced polymer, phenolic plastic, high-strength polycarbonate, fiberglass, or metal that are interleaved with layers of a soft polymer such as silicone, polyethylene, or rubber). The hardness of a material can be determined from its resistance to indentation when pressed upon, metals being harder than polymers.

A fastener insulator 230 can be used to electrically insulate the inertial damper 250 from the gap bolt(s) 112 and damper bolt(s) 220. In some cases, the fastener insulator may be one or more insulators as described in connection with FIG. 3A and FIG. 3B. The fastener insulator 230 may be formed from a polymer, fiber-reinforced polymer, fiberglass, ceramic, or some combination thereof. A force plate 224 may be used to distribute forces from the bolt heads and nuts over a larger area of the fastener insulator(s) 230. The force plate 224 can be formed from a metal. An inertial-damper insulator 232 can be used to electrically insulate the inertial damper 250 from the core portion 211. The inertial-damper insulator 232 can be formed from a polymer, fiber-reinforced polymer, fiberglass, ceramic, or some combination thereof. The inertial-damper insulator 232 may extend between surfaces of the core portion and inertial damper that would otherwise come into contact with each other when the multi-fed magnetic coil assembly 200 is bolted together. A thickness of the fastener insulator 230 and/or inertial-damper insulator 232 may be between 1 mm and 30 mm.

FIG. 3A and FIG. 3B depict examples of insulating elements that may be used for bolts in the magnetic coil assembly 200. In some cases, an insulator 300 for a bolt or hole through which the bolt passes may be formed as a tube 310 with one or two flanges 320 that extend over one or both surfaces 352, 354 of the material 350 through which the bolt passes, as depicted in FIG. 3A. The flange(s) 320 may prevent arcing from the bolt shaft to a surface of the material. In such cases, the insulator 300 may be formed in place, molded, or formed as halves that are joined together or inserted into the hole from opposite sides. The insulator 300 may be formed from a polymer, fiber-reinforced polymer, fiberglass, ceramic, or some combination thereof. The insulator 300 can also be sized to allow for free motion of the bolt with respect to the insulator. For example, there can be a gap between an inner diameter of the insulator and an outer diameter of a bolt passing through the insulator.

FIG. 3B depicts another example of an insulator 302 for a bolt that may be used between plates 360 (e.g., between an inertial damper 250 and core portion 211 or between a feed plate 215 and an adjacent return plate 217). The insulator 310 may comprise a tube 310 and a flange 320 located between ends of the tube 310 where the flange extends outward beyond an outer diameter of the tube. The insulator may be formed in place, molded, or formed in parts that are assembled together (e.g., as a tube 310 and washer that is placed on the tube). A thickness of the flanges 320 for the insulators 300, 302 may be between 1 mm and 300 mm. A wall thickness of the tubes 310 may be between 0.5 mm and 100 mm.

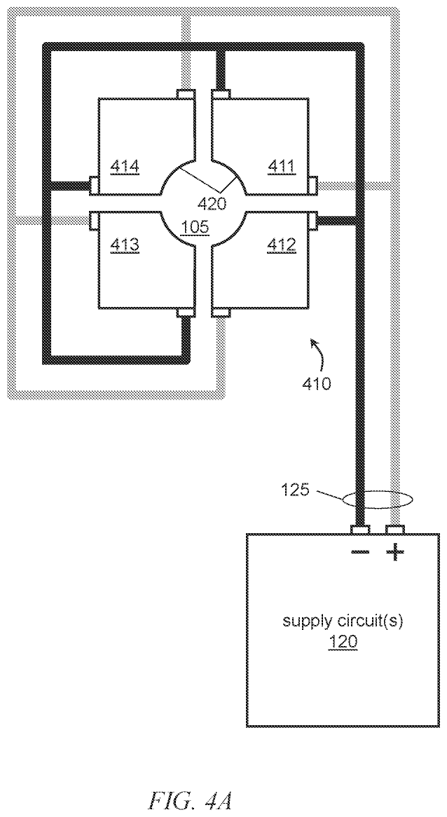

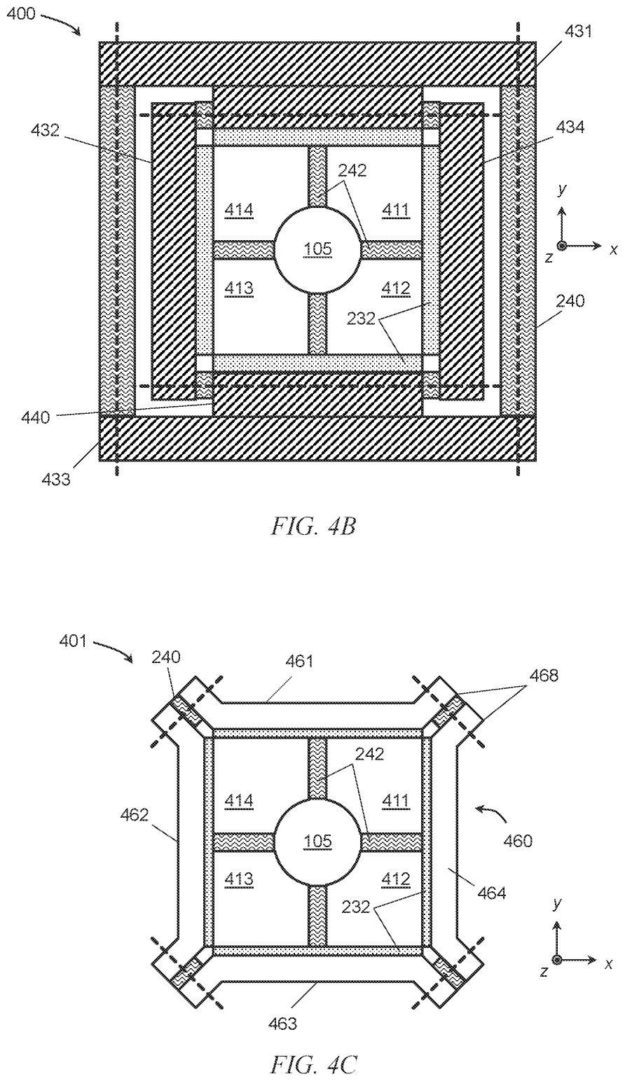

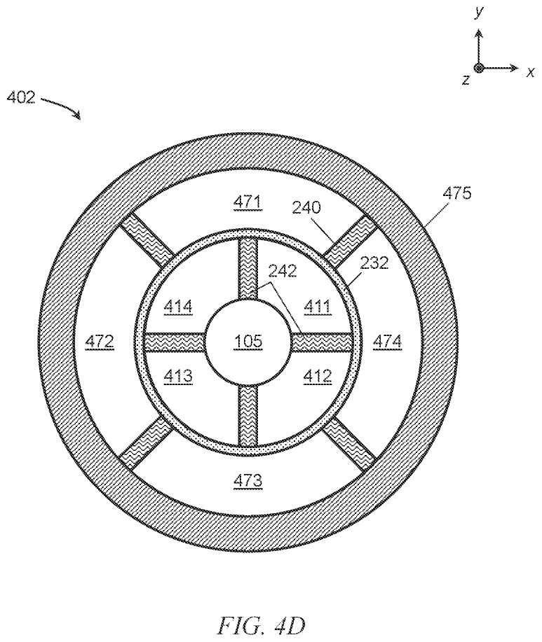

FIG. 4A depicts a quarter-turn, multi-segmented magnetic coil 410 and indicates one example of how coils with more than two core portions can be electrically connected to one or more supply circuits 120. Like the half-turn coil of FIG. 2, each core portion 411, 412, 413, 414 can separately connect to the supply circuits terminals such that current flows in a same direction (counterclockwise in the illustrated example) around an inner wall 420 of the coil 410. The voltage drop around the coil 410 is 4×V where V is the voltage of the supply circuit(s) 120.

One way to support the core portions 411, 412, 413, 414 is depicted in the elevation view of FIG. 4B. Support bars 431, 432, 433, 434 can be placed around the core portions and bolts used to clamp the core portions together in the x and y directions. The support bars can be formed from a non-magnetic metal and provide sufficient mass and inertial damping like the inertial dampers 250 of FIG. 2. The locations of bolts are indicated by the dashed lines. To allow for free movement of the support bars in the x and y directions for clamping, oversized holes, channels or tubes 440 (e.g., with square or rectangular cross sections) can be used where a bolt extends along an inside of the tube or channel. The channels 440 may be attached to an associated support bar (431, 433 in the illustrated example) or may be integrally formed within the support bar. Spaces between the core portions, between core portions and supports, and between support components can be filled, at least in part, with energy absorbers 240, 242 and/or other dielectric insulators 232 that are described above in connection with FIG. 2. Fastener insulators 230 and force plates can also be used, as described above in connection with FIG. 2.

FIG. 4C depicts, in elevation view, an alternative support structure 460 for a quarter-turn magnetic coil. The support structure 460 comprises four support bars 461, 462, 463, 464 with angled ends 468. The angled ends can allow for bolting therethrough to clamp and apply force to the core portions 411, 412, 413, 414 along the x and y directions. The support bars can be formed from a non-magnetic metal and provide sufficient mass and inertial damping like the inertial dampers 250 of FIG. 2. Support bars with angled ends can be used for other coil designs that have fewer (e.g., 3) core portions or more core portions. Spaces between the core portions, between core portions and supports, and between support components can be filled, at least in part, with energy absorbers 240, 242 and/or other dielectric insulators 232 that are described above in connection with FIG. 2. Fastener insulators 230 and force plates can also be used, as described above in connection with FIG. 2.

FIG. 4D depicts another implementation of support structure for a magnetic coil having four core portions 411, 412, 413, 414, though the support structure can be implemented for a magnetic coil having fewer or more core portions. The assembly includes four support elements 471, 472, 473, 474, though fewer or more support elements can be used. The support elements can provide mass for inertial damping as described above. A surrounding fastener 475 can participate in mechanically coupling the core portions and support elements together to restrain outward motion of the core portions and support elements. There can be energy-absorbing elements 240 and/or insulators 232 (as described above in connection with FIG. 2) between the core portions, between the core portions and support elements, and between the support elements. The surrounding fastener 475 can be made from insulating material (e.g., a fiber-reinforced polymer) and firmly hold the inner elements of the magnetic coil assembly in place. For example, the elements and insulators may all friction fit within the surrounding fastener 475. As another example, the surrounding fastener 475 can comprise carbon-fiber or other fiber that surrounds the support elements 471, 472, 473, 474. In some implementations, the fiber may be in a polymer matrix that is cured with the support elements in place or integrated into the wrap. The surrounding fastener can be cylindrical having a length that spans one or more fractional-turn coils. There can be holes in the surrounding fastener to provide access for electrical wires to connect to the core portions. In some implementations, the surrounding fastener 475 can participate in absorbing and dissipating energy from outward motion of the support elements 471, 472, 473, 474 that occurs in response to magnetic pressure exerted on the core portions.

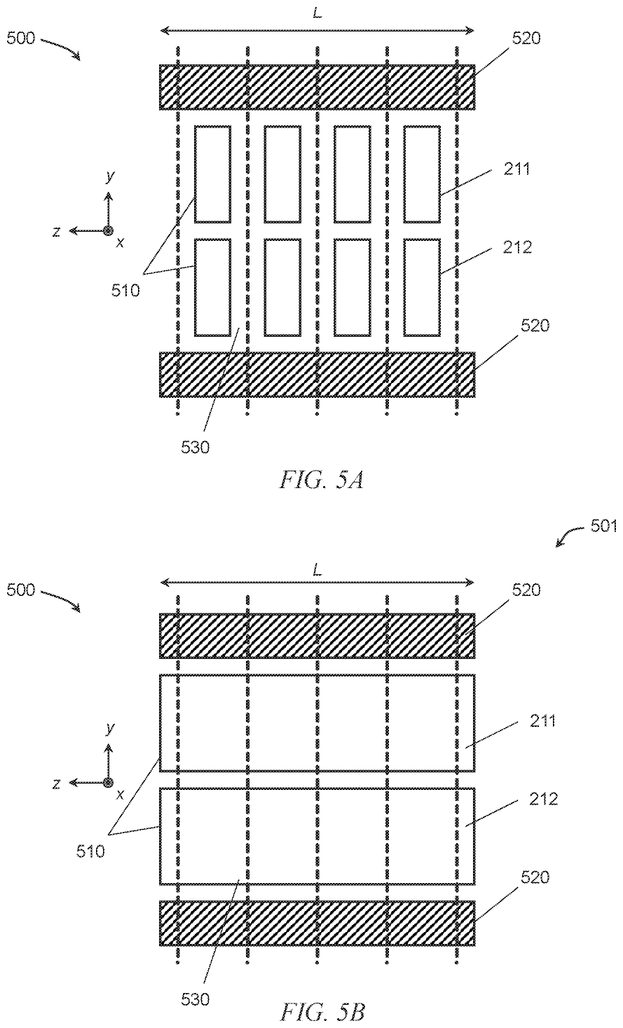

Axial support elements may be used in addition to or instead of the support structure depicted in FIG. 2, FIG. 4B and FIG. 4C. FIG. 5A depicts, in elevation and side view, a multi-core, fractional-turn magnetic coil assembly 500 that includes axial support elements 520. The axial support elements may be formed from a non-magnetic metal. The central axis of the magnetic coil assembly extends along the z direction. The axial support elements 520 may extend along the axis of the magnetic coil assembly (z direction) over multiple fractional-turn magnetic coils 510 and/or may extend up to the entire length L of the magnetic coil assembly 500.

The example of FIG. 5A has four fractional-turn magnetic coils 510, each having core portions 211, 212 that are juxtaposed along the z direction. The coils 510 may be spaced apart along the z axis. The fractional-turn magnetic coils 510 may be half-turn, third-turn, quarter-turn, fifth-turn, or sixth-turn magnetic coils, though other fractional-turn coils are possible. For half-turn coils, the axial support elements 520 can be located on only two opposing sides of the coil assembly as illustrated (e.g., top and bottom) to clamp the core portions together. Bolting locations (indicated by the dashed lines) may be in spaces 530 between the coils 510 so that bolt holes and bolts need not pass through the core portions 211, 212. Spaces 530 between the coils 510, gaps between the core portions 211, 212, spaces between core portions and support elements, and spaces between support elements 520 can be filled, at least in part, with energy absorbers, inertial-damper insulators, and/or other dielectric insulators that are described above in connection with FIG. 2. Fastener insulators 230 and force plates 224 can also be used, as described above in connection with FIG. 2.

For coil assemblies with a larger number of core portions (e.g., third-turn cores, quarter-turn cores, etc.), more axial support elements 520 may be placed around the core portions. In such cases, there may be two or more bolts in the space 530 between each coil extending in different directions so as to clamp the core portions with differently directed forces. The bolts can be offset from each other along the z direction within a space 530. Alternatively, there may be a single bolting direction between each coil 510, but the bolting direction may rotate along the coil assembly from space-to-space between each coil. For example and for a quarter-turn coil, the first bolting direction may be along the y direction. At the next space between coils 510, the bolting direction may be along the x direction. The direction of bolting may alternate from space-to-space along the coil assembly.

In some implementations, the axial support elements 520 provides inertial mass which participates in damping motion of the core portions in a magnetic coil assembly. In some cases, the axial support elements 520 can back (be mechanically coupled to) other support structure in a magnetic coil assembly. For example, the axial support elements can back the inertial dampers 250 of FIG. 2, the support bars 431, 432, 433, 434 of FIG. 4B, or the support bars 461, 462, 463, 464 of FIG. 4C. In some cases, the axial support elements 520 can be used as the supporting structure to restrain the core portions from outward motion and participate in inertially damping the core portions, and the support bars of FIG. 2, FIG. 4B, and FIG. 4C may not be used. In this case, the axial support elements can be shaped as plates that extend in the z direction up to the length L of the magnetic coil assembly 500 and thereby cover or back multiple core portions. Alternatively, any of the above-described support bars can extend in the z direction up to the length L of the magnetic coil assembly 500 and thereby cover or back multiple core portions. In such implementations, the mass of the axial support elements or the support bars can be at least 0.5 times the total mass of core portions backed by the axial support elements or the support bars.

In some implementations (depicted in FIG. 5B), the magnetic coil assembly 501 can have single fractional-turn core portions 510 extending along a length L of the coil assembly instead of multiple fractional-turn core portions mounted adjacent to each other along the length of the magnetic coil assembly 500. For example, each core portion 211, 212 may extend along the axial direction (z direction for the illustrated example) up to the length L of the magnetic coil assembly. To restrain the core portions 510 there can be multiple bolts distributed along the axial direction (locations indicated by the dashed lines). Such a configuration can provide higher uniformity of the magnetic field within the central cavity of the magnetic coil.

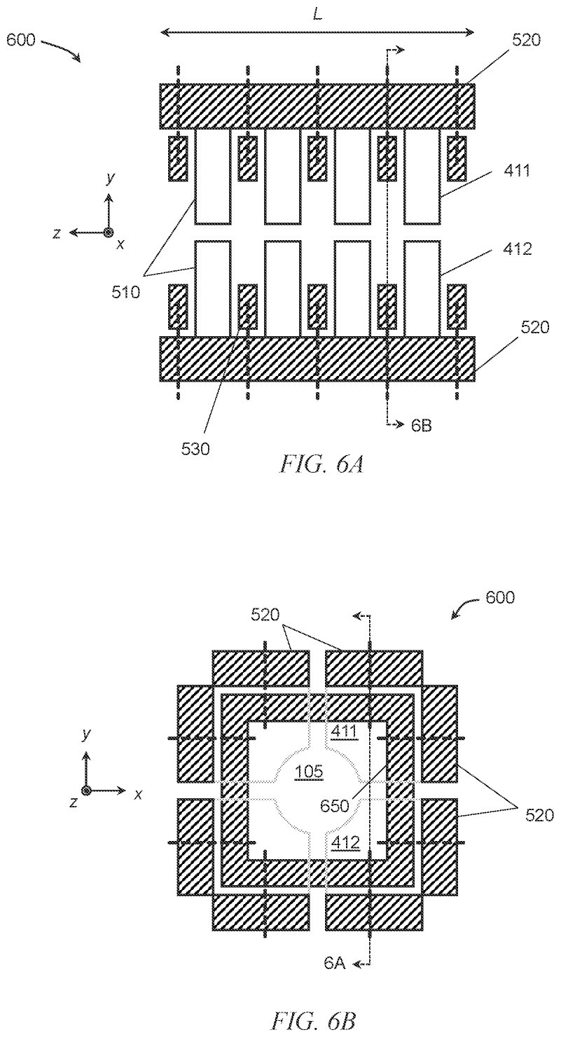

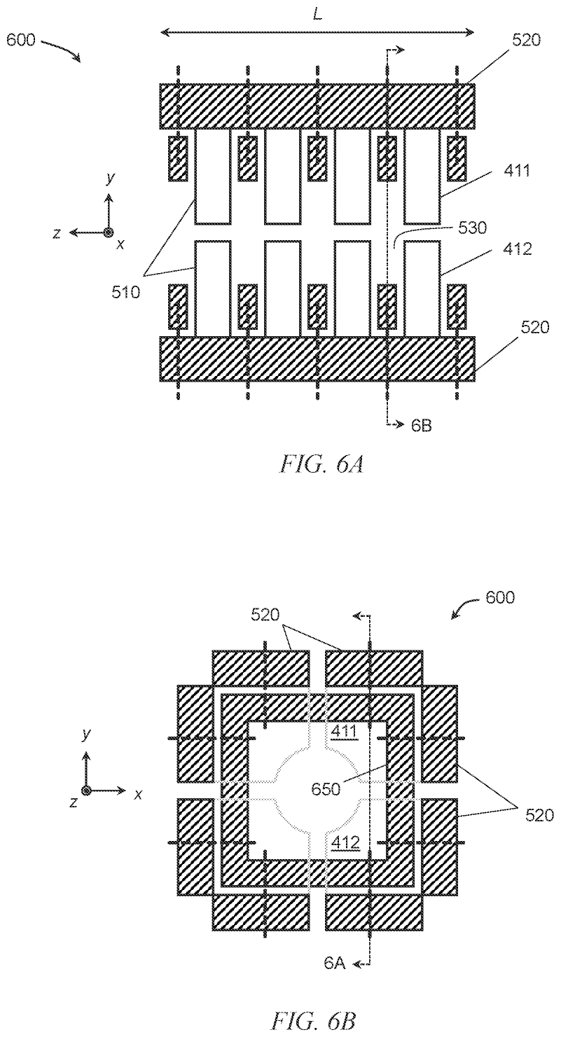

FIG. 6A and FIG. 6B depict another magnetic coil assembly 600 that can be used for magnetic cores having more than two core portions. The elevation views are cross sections, indicated by the dashed and arrowed lines 6A, 6B. The location of a single quarter-turn coil is depicted with gray-shaded lines in FIG. 6B. The magnetic coil assembly 600 comprises axial support elements 520 and one or more annular support elements 650 to which the axial support elements can be fastened. An annular support element 650 can be located in each space 530 between juxtaposed coils 510. Bolting locations are indicated by the heavy dashed lines. In some implementations, studs or threaded holes may be placed in the annular support element 650 and nuts or bolts, respectively, used to attach the axial support elements 520 to each annular support element 650 along a coil assembly.

Fasteners other than bolts and nuts may be used in some implementations of magnetic coil assemblies described above to mechanically couple together inertial dampers, support elements, and/or core portions. Other fasteners that may be used include rivets, locking pins, dowel pins, rods and pins, rods and retaining rings, binding barrels, screws, epoxies, or some combination of these fasteners. Other fasteners include clamping devices. Another fastener can include rings, tubes, or wraps that surround the inertial damping components and/or core portions, as described in connection with FIG. 4D. A combination of different fasteners and fastening paradigms can be used for some implementations.

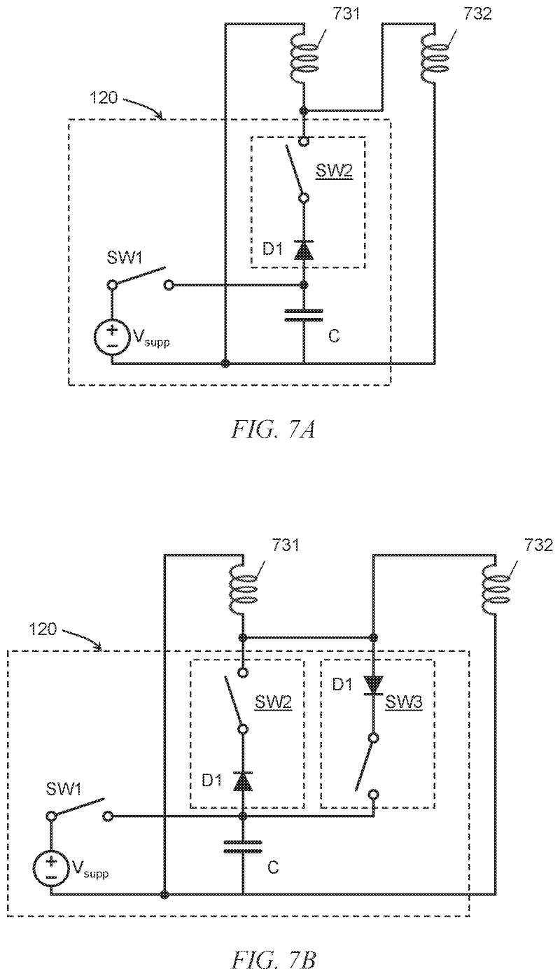

FIG. 7A depicts a simplified circuit schematic of a supply circuit 120 that can be used to deliver a pulse of current to one or more segments of multi-segmented coils 210, 410, 510 in a magnetic coil assembly of the above-described implementations. In the example circuit schematic, the supply circuit 120 is wired to deliver pulses of current to two core portions (e.g., the two core portions 211, 212 of FIG. 2), which are modeled as inductors 731, 732. In some cases, a plurality of such supply circuits 120 can be used to deliver current to one or more coils in the magnetic coil assembly or to one or more core portions. In some cases, a first core portion can be driven by one or more first supply circuits and a second core portion can be driven by one or more second supply circuits. The circuit includes an energy-storage element (modeled as a capacitor C), a source (modeled as a voltage supply Vₛᵤₚₚ, switches SW1, SW2. Switch SW2, comprising a diode D1, forms a directional switch through which current passes in one direction (a forward direction) when the switch is closed, and blocks reverse current flow. The switches may comprise silicon-controlled rectifiers (SCRs), for example, though other switches may be used.

During an operational cycle, switch SW1 may be closed at the beginning of the cycle (with switch SW2 open) to provide an initial charge to the energy-storage element C, which may be one or more capacitors. Switch SW1 may then open and switch SW2 close to deliver a pulse of current to the magnetic coil (modeled as an inductor). The peak amount of current delivered to each coil can be any value in a range from 100,000 amps (A) to 200,000,000 A, or any sub-range within this range (e.g., from 500,000 A to 200,000,000 A). In some cases, more current can be delivered to a core portion per pulse. The pulses of large currents delivered to the core portions can create an intense magnetic field in the interior cavity 105 of the magnetic coil assembly. The intense magnetic field can be used to confine and compress a plasma within the container or accelerate particles or objects.

Because of the inertial damping and energy dissipation provided by the support elements (which restrain outward motion of the core portions) and the insulating fillers (which can dissipate energy and assist in damping motion of the core portions), the magnetic coil assemblies can produce intense magnetic fields repetitively for many cycles without requiring replacement of assembly components. This is in contrast to some high-field devices which can require replacement of core liners after each firing or pulse of current. For the implementations described above, magnetic field intensities within the interior cavity 105 can have a peak value between 0.01 T and 50 T with each pulse, or within any sub-range between 0.01 T and 50 T (e.g., between 1 T and 20 T, between 10 T and 40 T, between 15 T and 35 T). The pulse duration can have any value in the ranges described above, for example, from 1 microsecond to 100 milliseconds, though shorter or longer pulses may be implemented in some applications. The number of firings of the magnetic coil assembly for at least some of these field intensities and pulse durations can be at least a value that is in a range between 100 and 1,000,000 (e.g., at least 1,000 times) before shutting down and maintenance or replacement of assembly components.

FIG. 7B is another simplified circuit schematic of a supply circuit that can be used to deliver current to one or more core portions of a multi-fed, multi-segmented magnetic coil assembly, such as the assembly of FIG. 2. The circuit of FIG. 7B can recover some of the energy that passes through the core portions. A second directional switch SW3 is included in the supply circuit 120. After current passes through the core portions during a first cycle, charge will accumulate on the energy-storage component (capacitor C), increasing its energy. Switch SW2 can then be opened and switch SW3 closed to allow current to flow back through the core portions (modeled as inductors 731, 732). The reverse flow of current recharges the energy-storage component C to a correct polarity for the start of the next cycle. Switch SW3 can then be opened to complete the first cycle. Switch SW1 can be closed to top off the charge on the energy-storage component C and initiate the start of the next cycle. The cycles can be repeated for the number of firings described above. Examples of other energy-recovery circuits that can be used for multi-segmented coils are described in U.S. provisional application Ser. No. 63/196,469 filed on Jun. 3, 2021, titled “Energy Recovery in Electrical Systems” and in international patent application Ser. No. PCT/US2022/032277 of the same title, filed Jun. 3, 2022, which applications are incorporated herein by reference in their entirety.

Although inertial damping is described above mainly for multisegmented coils, the inertial damping apparatus can be applied to a single-turn coil like that depicted in FIG. 1 (which can have a cylindrical shape as depicted, rectangular shape, or other shape). For example, opposing sides of the coil can be backed with massive inertial dampers (250) which are coupled together with fasteners to restrain outward motion of the core and prevent the core from opening. Energy-absorbing elements, inertial-damper insulators, and force plates can be used as described above to critically damp or overdamp mechanical oscillation of the single-turn coil that results from magnetic pressure on the coil.

Multi-fed, multi-segmented magnetic coil assemblies and methods of operating the coil assemblies can be implemented in different configurations, some examples of which are listed below.

(1) A magnetic coil assembly comprising: a first core portion partially surrounding a cavity of the magnetic coil assembly to carry a first electrical current to contribute to creating a magnetic field in the cavity; a second core portion partially surrounding the cavity to carry a second electrical current to contribute to creating the magnetic field, wherein the second core portion and the first core portion are configured to be electrically insulated from each other when the first core portion and the second core portion are not connected to one or more supply circuits; a first element mechanically coupled to the first core portion and having a first mass; a second element mechanically coupled to the second core portion and having a second mass; a first energy-absorbing element coupled to at least the first element to absorb first kinetic energy from motion of at least the first element in response to magnetic pressure on the first core portion and on the second core portion resulting from the creation of the magnetic field and to dissipate at least a portion of the absorbed first kinetic energy; and at least one fastener that mechanically couples the first element to the second element to restrain movement of the first core portion away from the second core portion in response to the magnetic pressure.
(2) The magnetic coil assembly of configuration (1), wherein the mass of the first element and the mass of the second element are selected to critically damp or overdamp mechanical oscillation of the magnetic coil assembly caused by the magnetic pressure.
(3) The magnetic coil assembly of configuration (1) or (2), wherein the first mass is between 0.5 times and 4 times the mass of the first core portion; and the second mass is between 0.5 times and 4 times the mass of the second core portion.
(4) The magnetic coil assembly of any one of configurations (1) through (3), wherein the first energy-absorbing element contributes to damping mechanical oscillation in the magnetic coil assembly that occurs in response to the magnetic pressure such that the mechanical oscillation continues for no more than three oscillation cycles.
(5) The magnetic coil assembly of any one of configurations (1) through (4), wherein the first energy-absorbing element comprises a fiberglass laminate.
(6) The magnetic coil assembly of any one of configurations (1) through (5), wherein the first energy-absorbing element comprises a laminate including interleaved layers of a first material and a second material, wherein a hardness of the first material is greater than a hardness of the second material.
(7) The magnetic coil assembly of any one of configurations (1) through (6), further comprising: a third core portion partially surrounding the cavity to carry a third electrical current to contribute to creating the magnetic field, wherein the third core portion, the second core portion, and the first core portion are configured to be electrically insulated from each other when the first core portion, the second core portion, and the third core portion are not connected to the one or more supply circuits, and wherein the first element or the second element is mechanically coupled to the third core portion.
(8) The magnetic coil assembly of any one of configurations (1) through (7), further comprising an inertial damping insulator disposed between the first element and the first core portion and coupled to at least the first element to absorb second kinetic energy from motion of at least the first core portion in response to the magnetic pressure.
(9) The magnetic coil assembly of configuration (8), wherein the inertial damping insulator is configured to dissipate at least a portion of the absorbed second kinetic energy.
(10) The magnetic coil assembly of any one of configurations (1) through (9), further comprising a second energy-absorbing element disposed between the first core portion and the second core portion to: absorb second kinetic energy from motion of the first core portion and the second core portion in response to the magnetic pressure; dissipate at least a portion of the absorbed second kinetic energy; and electrically insulate the first core portion from the second core portion.
(11) The magnetic coil assembly of any one of configurations (1) through (10), wherein a peak value of the magnetic field during operation is between 10 Tesla and 40 Tesla.
(12) The magnetic coil assembly of configuration (11), wherein the first element and the second element contribute to inertially damping mechanical oscillation of the magnetic coil assembly resulting from the magnetic pressure and allow the magnetic coil assembly to repeatedly create the magnetic field at least 1,000 times without replacing the first core portion or the second core portion.
(13) The magnetic coil assembly of any one of configurations (1) through (12), wherein a diameter of the cavity is between 1 centimeter and 300 centimeters.
(14) The magnetic coil assembly of any one of configurations (1) through (13), further comprising at least one fastener insulator to insulate the at least one fastener from at least one of the first core portion or the first element.
(15) The magnetic coil assembly of configuration (14), further comprising a force plate located between a head of a first fastener of the at least one fastener and a first fastener insulator of the at least one fastener insulator to distribute force from the head over a larger area than the head and onto the first fastener insulator.
(16) The magnetic coil assembly of any one of configurations (1) through (15) in combination with the one or more supply circuits, the one or more supply circuits comprising: at least one energy storage component to store electrical energy that can be discharged to at least the first core portion as the first electrical current; and at least one switch to discharge at least the first electrical current from the at least one energy storage component to the first core portion.
(17) The combination of configuration (16), wherein the one or more supply circuits is or are configured to apply approximately a same voltage to the first core portion and to the second core portion while discharging the first electrical current to the first core portion and while discharging the second electrical current to the second core portion.
(18) The combination of configuration (17), wherein the one or more supply circuits is or are configured to apply the same voltage to the first core portion and second core portion simultaneously.
(19) A method of operating a magnetic coil assembly, the method comprising: flowing a first electrical current in a first core portion that carries the first electrical current partially around a cavity, wherein the first core portion partially surrounds the cavity; flowing a second electrical current in a second core portion that carries the second electrical current partially around the cavity, wherein the second core portion partially surrounds the cavity; creating a magnetic field in the cavity in response to flowing the first electrical current and the second electrical current; restraining, with a first element that is mechanically coupled to the first core portion, outward motion of the first core portion from the cavity in response to first magnetic pressure on the first core portion resulting from creation of the magnetic field, wherein the first element has a first mass; and restraining, with a second element that is mechanically coupled to the second core portion and to the first element with at least one fastener, outward motion of the second core portion from the cavity in response to second magnetic pressure on the second core portion resulting from the creation of the magnetic field, wherein the second element has a second mass; absorbing, with a first energy-absorbing element coupled to at least the first element, first kinetic energy from motion of at least the first element in response to at least the first magnetic pressure on the first core portion; and dissipating at least a portion of the absorbed first kinetic energy.
(20) The method of (19), further comprising damping, with at least the first element, the second element, and the first energy-absorbing element, mechanical oscillation of the magnetic coil assembly caused by the first magnetic pressure and the second magnetic pressure such that the mechanical oscillation continues for no more than three oscillation cycles.
(21) The method of (19) or (20), wherein the first mass is between 0.5 times and 4 times a mass of the first core portion; and the second mass is between 0.5 times and 4 times a mass of the second core portion.
(22) The method of any one of (19) through (21), wherein the first energy-absorbing element comprises a laminate.
(23) The method of any one of (19) through (22), further comprising: absorbing, with an inertial damping insulator disposed between the first element and the first core portion and coupled to at least the first element, second kinetic energy from motion of at least the first core portion caused by the first magnetic pressure; and dissipating at least a portion of the absorbed second kinetic energy by the inertial damping insulator.
(24) The method of any one of (19) through (23), further comprising: absorbing, with a second energy-absorbing element disposed between the first core portion and the second core portion, second kinetic energy from motion of the first core portion and the second core portion caused by the first magnetic pressure and the second magnetic pressure; dissipating at least a portion of the absorbed second kinetic energy by the second energy-absorbing element; and electrically insulating the first core portion from the second core portion by the second energy-absorbing element.
(25) The method of any one of (19) through (24), wherein creating the magnetic field comprises producing a peak value of the magnetic field in the cavity that has a value in a range from 10 Tesla to 40 Tesla.
(26) The method of (25), further comprising creating the magnetic field at least 1,000 times in the cavity in succession with repeated pulses of the first electrical current and the second electrical current without replacing the first core portion or the second core portion.
(27) The method of any one of (19) through (26), wherein a diameter of the cavity is between 1 centimeter and 300 centimeters.
(28) The method of any one of (19) through (27), further comprising insulating, with at least one fastener insulator, the at least one fastener from at least one of the first core portion or the first element.
(29) The method of (28), further comprising distributing, with a force plate disposed between a head of a first fastener of the at least one fastener and a first fastener insulator of the at least one fastener insulator, force from the head over a larger area than the head and onto the first fastener insulator.
(30) The method of any one of (19) through (29), further comprising preloading the first element such that it applies a greater force to a central region of the first core portion near the cavity than end regions of the first core portion that are farther from the cavity.
(31) The method of any one of (19) through (30), further comprising: storing, in an energy storage component of at least one supply circuit, electrical energy; and discharging, with at least one switch, the stored energy to flow at least the first electrical current through the first core portion.
(32) The method of (31), wherein the discharging further comprises: flowing the second electrical current through the second core portion; and applying a same voltage to the first core portion and to the second core portion.
(33) The method of (32), wherein applying the same voltage comprises applying the same voltage simultaneously to the first core portion and to the second core portion.
(34) A magnetic coil assembly comprising: a first core portion partially surrounding a cavity of the magnetic coil assembly to carry a first electrical current to contribute to creating a magnetic field in the cavity; a second core portion partially surrounding the cavity to carry a second electrical current to contribute to creating the magnetic field, wherein the second core portion and the first core portion are electrically insulated from each other when the first core portion and the second core portion are not connected to one or more supply circuits; a first element mechanically coupled to the first core portion and having a mass at least 0.5 times a mass of the first core portion; a second element mechanically coupled to the second core portion and having a mass at least 0.5 times a mass of the second core portion; and at least one fastener that mechanically couples the first element to the second element to restrain movement of the first core portion away from the second core portion in response to magnetic pressure on the first core portion and on the second core portion resulting from the creation of the magnetic field.
(35) The magnetic coil assembly of configuration (34), wherein the mass of the first element and the mass of the second element are selected to damp mechanical oscillations of the magnetic coil assembly caused by the magnetic pressure such that the mechanical oscillation continues for no more than three oscillation cycles.
(36) The magnetic coil assembly of configuration (34) or (35), further comprising a first energy-absorbing element coupled to at least the first element to: absorb first kinetic energy from motion of at least the first element in response to magnetic pressure on the first core portion and on the second core portion resulting from the creation of the magnetic field; and dissipate at least a portion of the absorbed first kinetic energy.
(37) The magnetic coil assembly of configuration (36), further comprising a second energy-absorbing element disposed between the first core portion and the second core portion to: absorb second kinetic energy from motion of the first core portion and the second core portion in response to the magnetic pressure; dissipate at least a portion of the absorbed second kinetic energy; and electrically insulate the first core portion from the second core portion.
(38) The magnetic coil assembly of any one of configurations (34) through (37), wherein a peak value of the magnetic field during operation is between 10 Tesla and 40 Tesla.
(39) The magnetic coil assembly of any one of configurations (34) through (38), wherein the first element and the second element contribute to inertially damping mechanical oscillation of the magnetic coil assembly resulting from the magnetic pressure and allow the magnetic coil assembly to repeatedly create the magnetic field at least 1,000 times without replacing the first core portion or the second core portion.

### CONCLUSION

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize or be able to ascertain, using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used herein, should be understood to control over dictionary definitions, definitions in documents incorporated by reference, and/or ordinary meanings of the defined terms.

The indefinite articles “a” and “an,” as used herein in the specification and in the claims, unless clearly indicated to the contrary, should be understood to mean “at least one.”

The phrase “and/or,” as used herein in the specification and in the claims, should be understood to mean “either or both” of the components so conjoined, i.e., components that are conjunctively present in some cases and disjunctively present in other cases. Multiple components listed with “and/or” should be construed in the same fashion, i.e., “one or more” of the components so conjoined. Other components may optionally be present other than the components specifically identified by the “and/or” clause, whether related or unrelated to those components specifically identified. Thus, as a non-limiting example, a reference to “A and/or B”, when used in conjunction with open-ended language such as “comprising” can refer, in one embodiment, to A only (optionally including components other than B); in another embodiment, to B only (optionally including components other than A); in yet another embodiment, to both A and B (optionally including other components); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of components, and, optionally, additional unlisted items. Only terms clearly indicated to the contrary, such as “only one of” or “exactly one of,” or, when used in the claims, “consisting of,” will refer to the inclusion of exactly one component of a number or list of components. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more components, should be understood to mean at least one component selected from any one or more of the components in the list of components, but not necessarily including at least one of each and every component specifically listed within the list of components and not excluding any combinations of components in the list of components. This definition also allows that components may optionally be present other than the components specifically identified within the list of components to which the phrase “at least one” refers, whether related or unrelated to those components specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including components other than B); in another embodiment, to at least one, optionally including more than one, B, with no A present (and optionally including components other than A); in yet another embodiment, to at least one, optionally including more than one, A, and at least one, optionally including more than one, B (and optionally including other components); etc.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

1. A magnetic coil assembly comprising:
a first core portion partially surrounding a cavity of the magnetic coil assembly to carry a first electrical current to contribute to creating a magnetic field in the cavity;
a second core portion partially surrounding the cavity to carry a second electrical current to contribute to creating the magnetic field, wherein the second core portion and the first core portion are configured to be electrically insulated from each other when the first core portion and the second core portion are not connected to one or more supply circuits;
a first element mechanically coupled to the first core portion and having a first mass;
a second element mechanically coupled to the second core portion and having a second mass;
a first energy-absorbing element coupled to at least the first element to absorb first kinetic energy from motion of at least the first element in response to magnetic pressure on the first core portion and on the second core portion resulting from the creation of the magnetic field and to dissipate at least a portion of the absorbed first kinetic energy; and
at least one fastener that mechanically couples the first element to the second element to restrain movement of the first core portion away from the second core portion in response to the magnetic pressure.

2. The magnetic coil assembly of claim 1, wherein the mass of the first element and the mass of the second element are selected to critically damp or overdamp mechanical oscillation of the magnetic coil assembly caused by the magnetic pressure.

3. The magnetic coil assembly of claim 1, wherein:
the first mass is between 0.5 times and 4 times the mass of the first core portion; and
the second mass is between 0.5 times and 4 times the mass of the second core portion.

4. The magnetic coil assembly of claim 1, wherein the first energy-absorbing element contributes to damping mechanical oscillation in the magnetic coil assembly that occurs in response to the magnetic pressure such that the mechanical oscillation continues for no more than three oscillation cycles.

5. The magnetic coil assembly of claim 1, wherein the first energy-absorbing element comprises a fiberglass laminate.

6. The magnetic coil assembly of claim 1, wherein the first energy-absorbing element comprises a laminate including interleaved layers of a first material and a second material, wherein a hardness of the first material is greater than a hardness of the second material.

7. The magnetic coil assembly of claim 1, further comprising:
a third core portion partially surrounding the cavity to carry a third electrical current to contribute to creating the magnetic field, wherein the third core portion, the second core portion, and the first core portion are configured to be electrically insulated from each other when the first core portion, the second core portion, and the third core portion are not connected to the one or more supply circuits, and wherein the first element or the second element is mechanically coupled to the third core portion.

8. The magnetic coil assembly of claim 1, further comprising an inertial damping insulator disposed between the first element and the first core portion and coupled to at least the first element to absorb second kinetic energy from motion of at least the first core portion in response to the magnetic pressure.

9. The magnetic coil assembly of claim 8, wherein the inertial damping insulator is configured to dissipate at least a portion of the absorbed second kinetic energy.

10. The magnetic coil assembly of claim 1, further comprising a second energy-absorbing element disposed between the first core portion and the second core portion to:
absorb second kinetic energy from motion of the first core portion and the second core portion in response to the magnetic pressure;
dissipate at least a portion of the absorbed second kinetic energy; and
electrically insulate the first core portion from the second core portion.

11. The magnetic coil assembly of claim 1, wherein a peak value of the magnetic field during operation is between 10 Tesla and 40 Tesla.

12. The magnetic coil assembly of claim 11, wherein the first element and the second element contribute to inertially damping mechanical oscillation of the magnetic coil assembly resulting from the magnetic pressure and allow the magnetic coil assembly to repeatedly create the magnetic field at least 1,000 times without replacing the first core portion or the second core portion.

13. The magnetic coil assembly of claim 1, wherein a diameter of the cavity is between 1 centimeter and 300 centimeters.

14. The magnetic coil assembly of claim 1, further comprising at least one fastener insulator to insulate the at least one fastener from at least one of the first core portion or the first element.

15. The magnetic coil assembly of claim 14, further comprising a force plate located between a head of a first fastener of the at least one fastener and a first fastener insulator of the at least one fastener insulator to distribute force from the head over a larger area than the head and onto the first fastener insulator.

16. The magnetic coil assembly of claim 1 in combination with the one or more supply circuits, the one or more supply circuits comprising:
at least one energy storage component to store electrical energy that can be discharged to at least the first core portion as the first electrical current; and
at least one switch to discharge at least the first electrical current from the at least one energy storage component to the first core portion.

17. The combination of claim 16, wherein the one or more supply circuits is or are configured to apply approximately a same voltage to the first core portion and to the second core portion while discharging the first electrical current to the first core portion and while discharging the second electrical current to the second core portion.

18. The combination of claim 17, wherein the one or more supply circuits is or are configured to apply the same voltage to the first core portion and second core portion simultaneously.

19. A method of operating a magnetic coil assembly, the method comprising:
flowing a first electrical current in a first core portion that carries the first electrical current partially around a cavity, wherein the first core portion partially surrounds the cavity;
flowing a second electrical current in a second core portion that carries the second electrical current partially around the cavity, wherein the second core portion partially surrounds the cavity;
creating a magnetic field in the cavity in response to flowing the first electrical current and the second electrical current;
restraining, with a first element that is mechanically coupled to the first core portion, outward motion of the first core portion from the cavity in response to first magnetic pressure on the first core portion resulting from creation of the magnetic field, wherein the first element has a first mass; and
restraining, with a second element that is mechanically coupled to the second core portion and to the first element with at least one fastener, outward motion of the second core portion from the cavity in response to second magnetic pressure on the second core portion resulting from the creation of the magnetic field, wherein the second element has a second mass;
absorbing, with a first energy-absorbing element coupled to at least the first element, first kinetic energy from motion of at least the first element in response to at least the first magnetic pressure on the first core portion; and
dissipating at least a portion of the absorbed first kinetic energy.

20. The method of claim 19, further comprising damping, with at least the first element, the second element, and the first energy-absorbing element, mechanical oscillation of the magnetic coil assembly caused by the first magnetic pressure and the second magnetic pressure such that the mechanical oscillation continues for no more than three oscillation cycles.

21. The method of claim 19, wherein:
the first mass is between 0.5 times and 4 times a mass of the first core portion; and
the second mass is between 0.5 times and 4 times a mass of the second core portion.

22. The method of claim 19, wherein the first energy-absorbing element comprises a laminate.

23. The method of claim 19, further comprising:
absorbing, with an inertial damping insulator disposed between the first element and the first core portion and coupled to at least the first element, second kinetic energy from motion of at least the first core portion caused by the first magnetic pressure; and
dissipating at least a portion of the absorbed second kinetic energy by the inertial damping insulator.

24. The method of claim 19, further comprising:
absorbing, with a second energy-absorbing element disposed between the first core portion and the second core portion, second kinetic energy from motion of the first core portion and the second core portion caused by the first magnetic pressure and the second magnetic pressure;
dissipating at least a portion of the absorbed second kinetic energy by the second energy-absorbing element; and
electrically insulating the first core portion from the second core portion by the second energy-absorbing element.

25. The method of claim 19, wherein creating the magnetic field comprises producing a peak value of the magnetic field in the cavity that has a value in a range from 10 Tesla to 40 Tesla.

26. The method of claim 25, further comprising creating the magnetic field at least 1,000 times in the cavity in succession with repeated pulses of the first electrical current and the second electrical current without replacing the first core portion or the second core portion.

27. The method of claim 19, wherein a diameter of the cavity is between 1 centimeter and 300 centimeters.

28. The method of claim 19, further comprising insulating, with at least one fastener insulator, the at least one fastener from at least one of the first core portion or the first element.

29. The method of claim 28, further comprising distributing, with a force plate disposed between a head of a first fastener of the at least one fastener and a first fastener insulator of the at least one fastener insulator, force from the head over a larger area than the head and onto the first fastener insulator.

30. The method of claim 19, further comprising preloading the first element such that it applies a greater force to a central region of the first core portion near the cavity than end regions of the first core portion that are farther from the cavity.

31. The method of claim 19, further comprising:
storing, in an energy storage component of at least one supply circuit, electrical energy; and
discharging, with at least one switch, the stored energy to flow at least the first electrical current through the first core portion.

32. The method of claim 31, wherein the discharging further comprises:
flowing the second electrical current through the second core portion; and
applying a same voltage to the first core portion and to the second core portion.

33. The method of claim 32, wherein applying the same voltage comprises applying the same voltage simultaneously to the first core portion and to the second core portion.

34. A magnetic coil assembly comprising:
a first core portion partially surrounding a cavity of the magnetic coil assembly to carry a first electrical current to contribute to creating a magnetic field in the cavity;
a second core portion partially surrounding the cavity to carry a second electrical current to contribute to creating the magnetic field, wherein the second core portion and the first core portion are electrically insulated from each other when the first core portion and the second core portion are not connected to one or more supply circuits;
a first element mechanically coupled to the first core portion and having a mass at least 0.5 times a mass of the first core portion;
a second element mechanically coupled to the second core portion and having a mass at least 0.5 times a mass of the second core portion; and
at least one fastener that mechanically couples the first element to the second element to restrain movement of the first core portion away from the second core portion in response to magnetic pressure on the first core portion and on the second core portion resulting from the creation of the magnetic field.

35. The magnetic coil assembly of claim 34, wherein the mass of the first element and the mass of the second element are selected to damp mechanical oscillations of the magnetic coil assembly caused by the magnetic pressure such that the mechanical oscillation continues for no more than three oscillation cycles.

36. The magnetic coil assembly of claim 34, further comprising a first energy-absorbing element coupled to at least the first element to:
absorb first kinetic energy from motion of at least the first element in response to magnetic pressure on the first core portion and on the second core portion resulting from the creation of the magnetic field; and
dissipate at least a portion of the absorbed first kinetic energy.

37. The magnetic coil assembly of claim 36, further comprising a second energy-absorbing element disposed between the first core portion and the second core portion to:
absorb second kinetic energy from motion of the first core portion and the second core portion in response to the magnetic pressure;
dissipate at least a portion of the absorbed second kinetic energy; and
electrically insulate the first core portion from the second core portion.

38. The magnetic coil assembly of claim 34, wherein a peak value of the magnetic field during operation is between 10 Tesla and 40 Tesla.

39. The magnetic coil assembly of claim 38, wherein the first element and the second element contribute to inertially damping mechanical oscillation of the magnetic coil assembly resulting from the magnetic pressure and allow the magnetic coil assembly to repeatedly create the magnetic field at least 1,000 times without replacing the first core portion or the second core portion.
